(19) United States
(12) Patent Application Publication
(10) Pub. No.: US 2009/0024486 A1
(43) Pub. Date: Jan. 22, 2009

(54) ONLINE MARKETPLACE FOR INTELLECTUAL PROPERTY

(76) Inventor: Christophe J. P. Sevrain, Bloomfield Hills, MI (US)

Correspondence Address: c/o Robert Kelley Roth;Miller, Canfield, Paddock and Stone P.L.C., Suite 2500, 150 West Jefferson Ave., Detroit, MI, 48226, US

(21) Appl. No.: 12/036,601

(22) Filed: Feb. 25, 2008

Related U.S. Application Data
(63) Continuation-in-part of application No. 11/937,689, filed on Nov. 9, 2007.
(60) Provisional application No. 60/950,183, filed on Jul. 17, 2007.

(51) Int. Cl. G06Q 30/00

(52) U.S. Cl. 705/26

(57) ABSTRACT

A method for providing an internet network based marketplace for intellectual property assets comprises the steps of producing a list of intellectual property assets which a poster wishes to license or sell, and making the list of intellectual property assets accessible to the network to viewers interested in licensing or acquiring one or more items on the list of intellectual property in a controlled format, wherein the list of intellectual property assets may be uploaded from a poster via a transfer of data over the internet. Either the poster or the viewer may be alerted in response to alert criteria about information pertaining to the list of intellectual property

### RELATED APPLICATIONS

This application is a Continuation-in-Part of U.S. patent application Ser. No. 11/937,689, filed on Nov. 9, 2007, which claims priority benefit of U.S. provisional patent application No. 60/950,183 filed on Jul. 17, 2007.

### FIELD OF THE INVENTION

This invention relates to an improved online marketplace, and more particularly to an online marketplace for intellectual property (IP) which is available for licensing or for sale.

### BACKGROUND OF THE INVENTION

Intellectual property (especially patents and trade secrets but also copyrights trademarks, design and plant patents, etc.) form an increasingly important part of the balance sheets of many companies. Intellectual property can be the basis for obtaining and securing market share in an industry, and the basis for license agreements and Joint ventures and other technology sharing arrangements.

As IP assets can be bought, licensed and sold, it is not necessary to be the inventor/creator or the initial owner of an IP asset in order to commercialize it. In fact, in many instances the inventor/creator or initial owner is not in a position to effectively commercialize a technology without help. Examples of this situation include situations where the inventor is the owner and an individual without significant resources; a university whose primary function is knowledge dissemination instead of commercialization of faculty/employee inventions; corporations which need intellectual property to obtain freedom to operate in a given area of technology; and corporations which perceive more value in developing other areas, or compete in one field and are willing to license the technology into another non-competing field.

Various public and private subscription-based databases of patents and published patent applications are known, such as www.uspto.gov and www.delphion.com, for example. However, these databases only provide information about the published documents in question and do not include non-published intellectual property, such as trade secrets, provisional patent applications, even inventions merely at the inventions disclosure state prior to any filing, and other confidential information. Nor do such published patent documents effectively communicate the underlying commercial value of the intellectual property asset, since that is not their intended function, nor do they indicate a field of use where a license might be available, nor do they provide direct information about who to contact if a buyer/licensee wants to contact the owner of the IP asset.

Some attempts have been made to try to commercialize intellectual property assets. For example, Intellectual property bid method and system, U.S. Patent Publication 2002/0082973 to Marbach, et a disclose a method, system, and computer program product for auctioning intellectual property. An intellectual property owner identifies property to be placed at auction. The owner further defines license information including a license right type, a business right type, and an intellectual property use type, which taken together with the property determines 8 minimum bid amounts. The method and system sends the bidder a bid form prompting the bidder to enter in the above mentioned information, and the bidders contact information. Upon receipt, the system registers the bidder and sends the validated bid amount information, not including the bidder's registration information, to the owner for evaluation and selection of the winning bidder. All received bids are maintained in confidence until the winning bidders are contacted at the auction's conclusion, while all non-winning bids are deleted. Auction systems such as those disclosed in Marbach et al for selling intellectual property assets have significant limitations because they presuppose a plurality of bidders. In many situations however, there may only be one bidder for a particular IP asset.

In some instances the seller/licensor and/or buyer/licensee may be interested in controlling or preventing complete information from being presented to the other party. Also, IP assets may be purchased outright or licensed in particular fields of use, and auction systems have difficulty accommodating varying demands of disparate buyers and licensees.

Another problem is that all the IP in a given area may be scattered among different owners and not easy to track down. For examples multiple universities and companies may have patents and patent applications on the same area of research. All of them may be interested in selling or licensing their technology. It would be desirable to provide a single convenient website where owners of intellectual property may post the assets they wish to sell and license, and where buyers and licensees of intellectual property may view such assets. It would also be desirable to provide an easier way for potential sellers and licensors of IP to upload many (hundreds or thousands) pieces of IP that they want to upload at once. It would also be desirable to provide a way for sellers and buyers of IP to be notified when intellectual property that they want to look at (or when someone is looking at their posted IP) is available.

### SUMMARY OF THE INVENTION

In accordance with a first aspect, a method for providing an internet network based marketplace for intellectual property assets, comprising, the steps of producing a list of intellectual property assets which a poster wishes to license or sell, and making the list of intellectual property assets accessible to the network to viewers interested in licensing or acquiring one or more items on the list of intellectual property in a controlled format, wherein the list of intellectual property assets may be uploaded from a poster via a transfer of data over the internet. assets may be uploaded from a poster via a transfer of data over the internet. The viewer may be alerted in response to alert criteria about information pertaining to the list of intellectual property. The poster may have a way to monitor which entity or individual has viewed the poster's listed IP, and/or may view which entity or individual has agreed to the online non-disclosure form.

From the foregoing disclosure and the following more detailed description of various preferred embodiments it will be apparent to those skilled in the art that the present invention provides a significant advance in the technology of marketplaces and listings for intellectual property. Particularly significant in this regard is the potential the invention affords for providing an easy to use system for identifying intellectual property available for licensing and sale and connecting buyers/licensees with sellers of IP assets. Additional features and advantages of various preferred embodiments will be better understood in view of the detailed description provided below.

### BRIEF DESCRIPTION OF THE DRAWINGS

FIG. 1 is a schematic flow chart of a marketplace for listing intellectual property available for licensing and/or sale in accordance with a preferred embodiment.

FIG. 2 shows an IP Listing Module of the marketplace described in FIG. 1.

FIG. 3 shows an IP Searching Module of the marketplace described in FIG. 1.

FIG. 4 shows an additional Support Module of the marketplace described in FIG. 1. The Support Module describes various additional services and resources which may be provided to buyers, sellers licensors and licensees of IP at the marketplace.

FIG. 5 shows sample screenshot where a seller/poster of IP may post registration information and post more specific information about the IP he wishes to sell or license.

It should be understood that the appended drawings are not necessarily to scale, do not necessarily include all the system components required for an actual implementation, and present a simplified representation of various preferred features illustrative of the basic principles of the invention. The specific design features of the system for listing intellectual property as disclosed here, including, for example, the specific user interface, will be determined in part by the particular intended application and use environment. Certain features of the illustrated embodiments have been enlarged or distorted relative to others to improve visualization and clear understanding. In particular, thin features may be thickened, for example, for clarity of illustration. All references to direction and position, unless otherwise indicated, refer to the orientation illustrated in the drawings.

### DETAILED DESCRIPTION OF CERTAIN PREFERRED EMBODIMENTS

It will be apparent to those skilled in the art, that is, to those who have knowledge or experience in this area of technology, that many uses and design variations are possible for the improved system for listing of intellectual property disclosed here. The following detailed discussion of various alternative and preferred features and embodiments will illustrate the general principles of the invention with reference to listing intellectual property, both confidential and non-confidential, which are available for licensing or for sale. Other embodiments suitable for other applications will be apparent to those skilled in the art given the benefit of this disclosure.

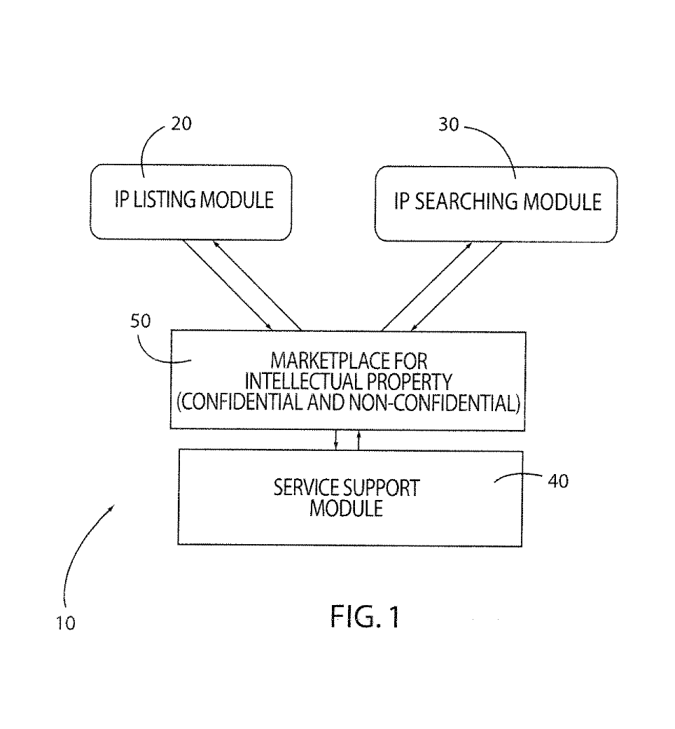

Referring now to the drawings, FIG. 1 shows a representative schematic flow chart 10 representing a marketplace 50 for posting IP available for sale and for buying or licensing that IP. In accordance with a highly advantageous feature, intellectual property assets which may be identified and posted to the marketplace can comprise, for example, not only patents, published pending patent applications, design patents, plant patents, copyrights, trademarks, etc., (i.e., non-confidential information) but also unpublished IP such as unpublished utility patent applications (principally those less than 18 months old under current law), invention disclosures and summary descriptions of trade secrets (Confidential information). Trade secrets may be posted in summary description form so as not to disclose the entire secret. For example an improved method of manufacturing a chemical may be indicated in terms of results (50% higher yields) rather than in terms of the steps or recipe associated with the manufacturing process that generates the desirable result.

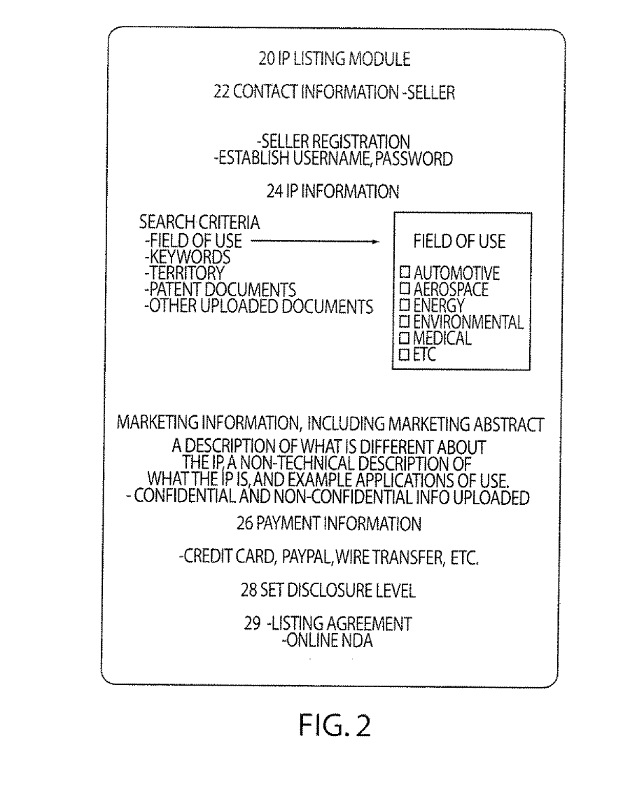

Whatever the type of IP, a poster or lister posts the IP to a marketplace 50. Typically the marketplace would be a website accessible by remote buyers, sellers/posters, support staff, administrative staff and other users. As used herein a buyer may also refer to a licensee of IP, and a seller, poster or lister may refer to a licensor of IP. A seller lists his IP at the IP listing module 20 shown in FIG. 2. The seller can comprise, for example, universities interested in licensing or selling their inventions, corporations that either are willing to sell their IP or license the IP in certain fields of use, individuals with limited marketing resources, and other institutions. The listing process includes the steps of Seller Registration, where the poster provides contact information 22 and is given a username and password. Typically this information is generated by presenting a series of screens at the website for the seller to complete. Preferably the poster of the IP is charged a fee for posting IP assets. This fee can vary depending upon the number of assets uploaded to the marketplace 50, and can be modified or even waived as desired by an operator of the IP marketplace website. Payment information 26 is collected from the seller. PayPal® or other known techniques for collecting payment over the internet (often via a credit or debit card) may be used, as well as wire transfers.

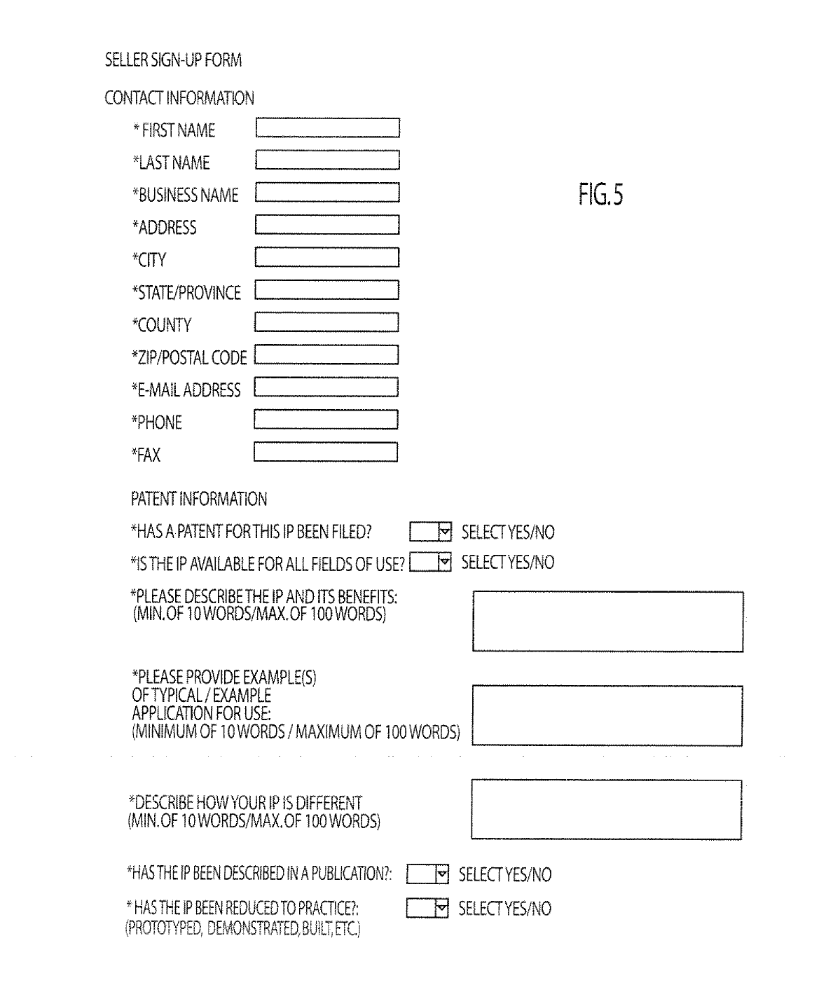

In addition to basic registration, the seller must provide information about the intellectual property to be sold or licensed. This IP information 24 can comprise, for example, the type of intellectual property and its status (utility patent, pending unpublished utility application, trade secret, etc.); a number, if any, such as a publication or registration number; documents uploaded by the seller or uploaded with the permission of the seller, a field of use available for license, or a geographic region or other territory available for license; and, in accordance with a highly advantageous feature, marketing information. FIG. 5 shows a representative sample poster sign in form which is preferably part of the online marketplace website.

Marketing information about the IP assets to be offered for sale or licensed is very important for assets that are described in highly structured legalistic language such as patents. Advantageously, marketing information is provided which helps a potential buyer better understand the scope and strengths of the underlying asset. Marketing information can comprise, for example, a description of some of the benefits of the IP; a description of how the IP is different from other known technology; a non-technical description of the IP, examples of applications of use, an indication of whether the IP covers a product or process which has been used in production; and whether prototypes have been built. Marketing information also preferably advantageously comprises each terms which are used by the marketplace to generate a searchable list of IP assets. A Marketing Abstract can succinctly summarize the advantages and differences of the IP asset. For example the Marketing Abstract can take the form of a short description of the IP and its benefits (which technology, which field of use, potential market size, estimates of profits, etc.) and a short description of how the IP is different than existing technologies as seen in FIG. 5. Information is provided to the website by the Seller via fill-in forms, drop down boxes (such as, for example, the Field of Use boxes shown in FIG. 2), etc., for inputting appropriate information into a website. As noted above, advantageously these IP assets can include non-published and confidential intellectual property. Preferably each field, including keywords, uploaded files, patent PDF documents, any checked boxes, etc., are searchable by potential buyers.

Advantageously this online system helps with rapid dissemination of commercially available potentially patentable subject matter in one convenient location which can be scrutinized by potential buyers. Without this marketplace such inventions would be unpublished for at least 18 months after the filing of a patent application, or if published, an owner would have to track down and find a way to direct multiple potential buyers to his publication; clearly a very unappealing and tedious process.

Set Disclosure Level 28. After the Seller/Poster establishes the IP assets that he wishes to sell in the marketplace, the Seller can set a level of confidentiality within the marketplace, deciding whether to reveal its identity to potential Buyers. Thus, the list of IP assets available for license or for purchase is presented to Buyers in a controlled format. For example, a trade secret may be presented in summary form, and the identity of the seller may optionally remain confidential between the marketplace operator and the seller—not provided to the Buyer.

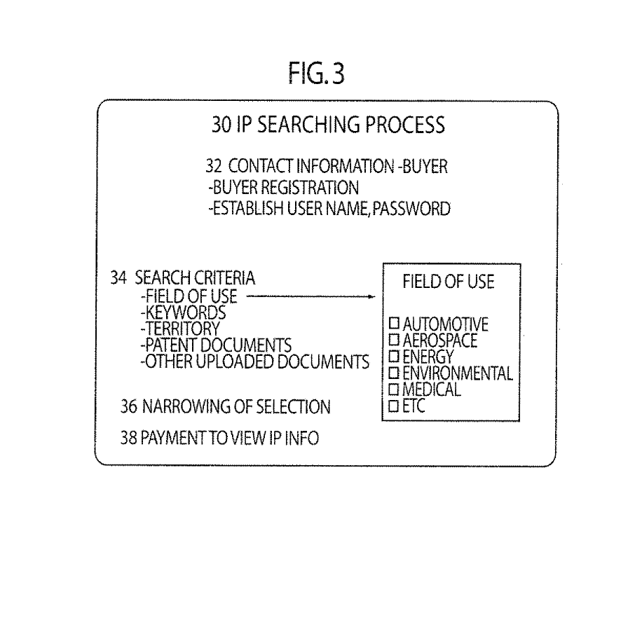

IP Searching Module 30. A potential licensor or acquirer of IP (Buyer) provides relevant contact information at the Search Module 30 shown in FIG. 3. The viewer/Buyer completes a Buyer Registration and is issued a username and password in a manner similar to what the Poster does to start the process. Preferably information is accessible on the website only after logging in. The first part of the process may be the same, with a user indicating whether they are a buyer or seller of IP. If they are a buyer or potential buyer, the next step would comprise searching for the particular intellectual property. To search for intellectual property assets, fill-in forms, drop down boxes, text search, uploaded documents, etc. are used. As shown in FIG. 3, a Field of Use checklist may be provided, allowing the viewer to make a selection to help identify and locate specific intellectual property assets. The list of available intellectual property based on keyword search terms and other information input by the Seller is generated. Further narrowing of the search criteria 36 to hone in on a desired selection may be done as well. Optionally the viewer may be charged a fee for the privilege of viewing the IP with supporting information including uploaded documents and marketing information available for license or for sale.

In accordance with a preferred embodiment, the resulting list generated for the Buyer does not necessarily provide patent or application numbers, patent titles, inventors, or other sensitive information. Non-sensitive information will be provided to indicate the general availability of the IP. Thus, in this embodiment, the information is provided to potential buyers in a controlled format. The Buyer can then narrow down the search criteria as a means to understand IP availability and specific concept. If the buyer wishes to pursue a listed IP asset they may be required to register to view information on the pieces of IP at a nominal, per IP price. If the intellectual property is confidential, the potential buyer will be required to enter into a non-disclosure agreement. In addition, the marketplace can provide for confidentiality of viewers until they elect to establish contact with the poster, either through the website or directly with the seller.

In accordance with a highly advantageous feature, the list of intellectual property assets may be uploaded from a poster or more particularly a poster's website via a transfer of data over the internet. Such data can be in one of several forms. For example, the data may be uploaded manually from a poster or more particularly a poster's website via a transfer of data over the internet. Such data can be in one of several forms. For example, the data may be uploaded manually by the poster, or automatically from the poster using a spider program which collects the data from a website of the poster. Alternatively, the data can comprise an extensible markup language such (XML) which is good for the transfer of structured data over the internet, or comma separated values (CSV), which is good for handling data transfers over the internet in tabular form. Other suitable programs, languages and file formats suitable for data transfer from the poster will be readily apparent to those skilled in the art given the benefit of this disclosure.

At registration, preferably both the Seller/Poster and potential Buyers/Buyers enter into the Listing/Buying contract with the online marketplace operator. The Listing/Buying contract may require the sellers agree to post their information in a redacted (controlled) format where patent or patent application numbers, patent titles, inventors, or other identification information which identifies the asset or the owner of the asset are not provided to the buyers and potential buyers. Each Listing/Buying contract can also optionally include conditions requiring exclusive use of the online marketplace for completing a transaction (purchase or license) of the IP from the seller to the buyer. The online marketplace operator may charge a fee for each such completed transaction.

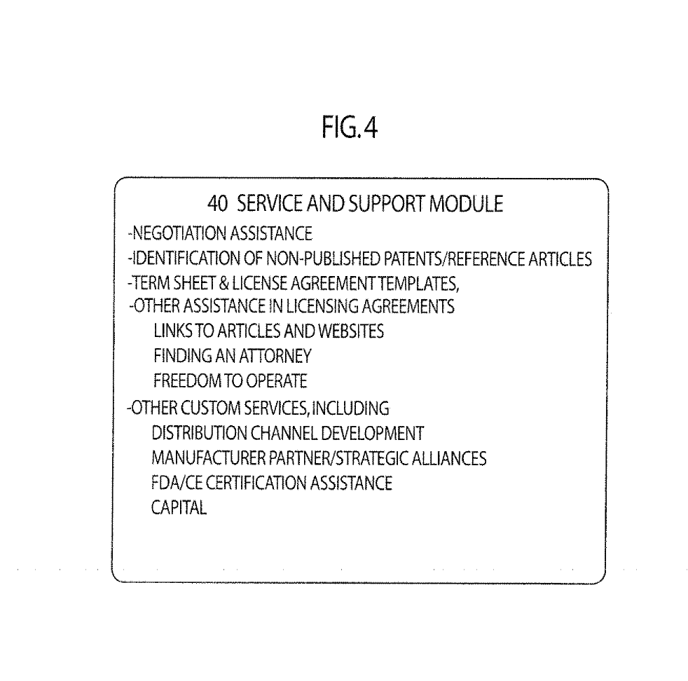

Service and Support Module 40. Buying and selling of intellectual property assets often is a complicated transaction, especially given the uniqueness of such assets. Therefore additional support is offered by the marketplace operator on the website at a Support Module 40 accessible by both the posters and by viewers/potential buyers and shown in FIG. 4. This support can comprise one or more of several items, including, for example, negotiation assistance; identification of other non-published patents and reference articles; links to support service organizations, such as a partner's network; help finding intellectual property attorneys and preparation of freedom to operate opinions; assistance finding distribution channels (for new licensees); assistance finding contract manufacturers (for new licensees); assistance creating strategic alliances; FDA/CE certification assistance (with intellectual property pertaining to drugs and medical devices); other regulatory assistance; assistance in finding financing, etc. Other useful services and resources such as license agreement templates and links to other websites may be provided and will be readily apparent to those skilled in the art given the benefit of this disclosure.

Fees may be charged by the marketplace operator at various steps in the process, including:

1. A fee may be charged each poster for posting intellectual property to the online marketplace (Posting Fee). The posting fee can be zero, or set for a limited period of time, or unlimited.

2. A fee may be charged each viewer of the selected intellectual property (Buyer/Potential Buyer/Viewing Fee). The fee can be zero, or a fee for an unlimited number of views for a period of time, or a per view fee.

3. A fee may be charged by the website operator any time an agreement is completed between two parties who entered into a listing and buying contract (Selling fee).

4. Advertising fees may be charged such as banner advertisements or sponsorships on the website.

5. Consulting fees, either by the marketplace operator or by an affiliated entity.

In addition, the website developer may provide other services to the posters and to the buyers. Not all of the fees need necessarily be charged. For example, a more open system could charge a posting fee, but waive the viewing fee and the selling fee. In this method of selling intellectual property assets via an online marketplace, the controlled format of presentation of information to the buyers and potential buyers would include, for example, contact information of the seller and identification numbers for the intellectual property assets, where applicable. Other variations of fee arrangements will be readily apparent to those skilled in the art given the benefit of this disclosure.

The poster of IP assets may wish to see what viewers are looking at its IP, or have signed their non-disclosure agreement etc. In accordance with a highly advantageous feature, the poster may set alert criteria wherein the poster is alerted when an event occurs preselected by the poster, or simply view a log of such activities. The alert can comprise for example, an e-mail or text message which includes information such as for example the number of views of any intellectual property asset, and the number of different views by individual viewers. Additional alert information will be readily apparent to those skilled in the art given the benefit of this disclosure. The alert criteria may comprise information pertaining to the list of intellectual property, such as when a viewer looks at the poster's IP, signs a non-disclosure agreement, etc., and may also include a preselected period of time.

In a similar manner, the viewer of the IP assets may by interested in being alerted when IP assets appear that meet the viewer's preferences. The alert criteria used may be set by information pertaining to the list of intellectual property, including keywords such as those used in the search criteria mentioned above, (inventor, technology) for example, or another field of use related to the IP assets the viewer is interested in viewing. As with the poster alert, the viewer alert can comprise for example, an e-mail or text message for example. Other alert criteria for both posters and for viewers will be readily apparent to those skilled in the art given the benefit of this disclosure.

From the foregoing disclosure and detailed description of certain preferred embodiments, it will be apparent that various modifications, additions and other alternative embodiments are possible without departing from the true scope and spirit of the invention. The embodiments discussed were chosen and described to provide the best illustration of the principles of the invention and its practical application to thereby enable one of ordinary skill in the art to use the invention in various embodiments and with various modifications as are suited to the particular use contemplated. All such modifications and variations are within the scope of the inventon as determined by the appended claims when interpreted in accordance with the breadth to which they are fairly, legally, and equitably entitled.

What is claimed is:

1. A method for providing an internet network based marketplace for intellectual property assets, comprising, in combination, the steps of:
producing a list of intellectual property assets which a poster wishes to license or sell; and
making the list of intellectual property assets accessible to the network to viewers interested in licensing or acquiring one or more items on the list of intellectual property in a controlled format;
wherein the list of intellectual property assets may be uploaded from a poster via one of manual entry and a transfer of data over the internet.

2. The method of claim 1 wherein the list of intellectual property assets is uploaded automatically from the poster using a spider program which collects the data from a website of the poster.

3. The method of claim 1 wherein the data is structured as one of an extensible markup language (XML) and comma separated values (CSV).

4. A method for providing an internet network based marketplace for intellectual property assets, comprising, in combination, the steps of:
producing a list of intellectual property assets which a poster wishes to license or sell;
making the list of intellectual property assets accessible to the network to viewers interested in licensing or acquiring one or more items on the list of intellectual property; and
alerting one of the poster and the viewer in response to alert criteria set by the same one of the poster and the viewer about information pertaining to the list of intellectual property.

5. The method of claim 4 wherein the alert criteria comprises when a viewer views an intellectual property asset, and when search criteria are met.

6. The method of claim 5 wherein the search criteria comprise key phrases, inventor names, and periods of time.

7. The method of claim 4 wherein the step of alerting comprises sending an e-mail message sent to the one of the viewer and the poster.

8. The method of claim 4 further comprising
making the list of intellectual property assets accessible to the network in a controlled format to viewers interested in licensing or acquiring one or more items on the list of intellectual property;
wherein the controlled format comprises restricting identification information from view by the viewers.

9. The method of claim 8 wherein the identification information comprises identification numbers, titles, inventors and owners of the intellectual property.

10. The method of claim 4 wherein the intellectual property assets comprise at least one of utility patents, published and unpublished utility patent applications and summary descriptions of trade secrets.

11. The method of claim 4 further comprising an intellectual property buying module where the viewer identifies search criteria for identifying and locating specific intellectual property assets which the viewer is interested in viewing;
wherein the search criteria comprise at least one of keywords and a field of use related to the intellectual property assets the viewer is interested in viewing.

12. The method of claim 4 wherein the list includes marketing information about each intellectual property asset on the list, and the marketing information comprises a marketing abstract which comprises a description of some of the benefits of the intellectual property asset; a description of how the intellectual property asset is different from other known technology; a non-technical description of the intellectual property asset; and examples of applications of use of the intellectual property asset.

13. The method of claim 4 wherein the step of alerting comprises providing a poster access to a log of views viewer of the list of intellectual property assets.
